(19) United States
(12) Patent Application Publication
(10) Pub. No.: US 2026/0296071 A1
(43) Pub. Date: Oct. 1, 2026

(54) PRINTING DEVICE

(71) Applicant: SEIKO EPSON CORPORATION, Tokyo (JP)

(72) Inventors: Kazuhisa KATO, MATSUMOTO-SHI (JP); Takahiro MIYAMOTO, MATSUMOTO-SHI (JP); Musashi YANAGISAWA, SHIOJIRI-SHI (JP); Yuto ONO, SHIOJIRI-SHI (JP)

(21) Appl. No.: 19/577,721

(22) Filed: Mar. 25, 2026

(30) Foreign Application Priority Data
Mar. 25, 2025 (JP) 2025-049389

(51) Int. Cl. B41J 15/04; B41J 13/10; B41J 13/14; B41J 13/24

(52) U.S. Cl. CPC B41J 15/04; B41J 13/103; B41J 13/14; B41J 13/24

(57) ABSTRACT

According to an aspect of the present disclosure, there is provided a printing device including a conveyance section, a printing section, and a plurality of restriction members configured to restrict movement of a medium in a width direction. The restriction members are disposed side by side in the width direction and are turnable centering on a support shaft having a rotation axis in the width direction. In a state in which the medium is absent in a conveyance path, a contact section is located at an entry position where the contact section blocks a course of the medium in a conveyance direction. As the medium is conveyed and a downstream end portion in the conveyance direction of the medium comes into contact with the contact section from upstream in the conveyance direction, the contact section turns centering on the support shaft to retreat from the entry position to a retraction position where the contact section does not block the course.

The present application is based on, and claims priority from JP Application Serial Number 2025-049389, filed Mar. 25, 2025, the disclosure of which is hereby incorporated by reference herein in its entirety.

### BACKGROUND

### 1. Technical Field

The present disclosure relates to a printing device.

### 2. Related Art

Various printing devices have been used. Among these printing devices, there is a printing device that conveys a medium and performs printing on the conveyed medium. In the printing device having the configuration described above, in order to prevent, for example, the medium from skewing or deviating in the width direction intersecting a conveyance direction, a restriction member that restricts movement of the medium in the width direction is sometimes provided. For example, JP-A-2014-218349 discloses a printing device including a mechanism that can guide, by closing an upper lid in a state in which the medium is present below the restriction sections, a medium at a desired width with a plurality of restriction sections provided on the upper lid.

JP-A-2014-218349 is an example of the related art.

In a configuration in which a roll-shaped medium is used, for example, when the medium is replaced, since the medium is once rewound further upstream than a restriction member and conveyed again, work is facilitated. However, in the printing device disclosed in JP-A-2014-218349, when the medium is once rewound further upstream than the restriction section and is conveyed again, all of a plurality of restriction sections descend to a position where the plurality of restriction sections block the path of the medium. Since the respective restriction sections do not retract even when coming into contact with the leading end of the medium at the position where the restriction sections descend downward, media other than a medium having width narrower than an interval between the restriction sections is caught by the restriction sections and cannot be conveyed. There is a likelihood that, even if the medium having the width narrower than the interval between the restriction sections is conveyed, the conveyed medium skews to be caught by the restriction sections and cannot be conveyed.

### SUMMARY

According to an aspect of the present disclosure, there is provided a printing device including: a conveyance section configured to convey a medium in a conveyance direction along a conveyance path; a printing section facing the medium conveyed in the conveyance path; and a plurality of restriction members located further upstream than the printing section in the conveyance direction of the conveyance path and configured to restrict movement of the medium in a width direction intersecting the conveyance direction, wherein the restriction members are disposed side by side in the width direction and are turnable centering on a support shaft having a rotation axis in the width direction, in a state in which the medium is absent in the conveyance path, a contact section is located at an entry position where the contact section blocks a course of the medium in the conveyance direction, and, as the medium is conveyed and a downstream end portion in the conveyance direction of the medium comes into contact with the contact section from upstream in the conveyance direction, the contact section turns centering on the support shaft to retreat from the entry position to a retraction position where the contact section does not block the course.

### BRIEF DESCRIPTION OF THE DRAWINGS

FIG. 1 is a side cross-sectional view illustrating an internal configuration of a printing device according to an embodiment of the present disclosure.

FIG. 2 is a perspective view illustrating a restriction member and a support member of the printing device illustrated in FIG. 1.

FIG. 3 is a side cross-sectional view illustrating a conveyance path, the restriction member, and the support member of the printing device illustrated in FIG. 1.

FIG. 4 is a perspective view of the restriction member and the support member of the printing device illustrated in FIG. 1 viewed from obliquely above.

FIG. 5 is a perspective view illustrating how the restriction member of the printing device illustrated in FIG. 1 is attached to the support member.

FIG. 6 is a perspective view illustrating the restriction member of the printing device illustrated in FIG. 1.

FIG. 7 is a perspective view of a part of the restriction member of the printing device illustrated in FIG. 1 viewed from a taper shape side.

### DESCRIPTION OF EMBODIMENTS

First, the present disclosure is schematically explained.

According to a first aspect of the present disclosure, there is provided a printing device including: a conveyance section configured to convey a medium in a conveyance direction along a conveyance path; a printing section facing the medium conveyed in the conveyance path; and a plurality of restriction members located further upstream than the printing section in the conveyance direction of the conveyance path and configured to restrict movement of the medium in a width direction intersecting the conveyance direction, wherein the restriction members are disposed side by side in the width direction and are turnable centering on a support shaft having a rotation axis in the width direction, in a state in which the medium is absent in the conveyance path, a contact section is located at an entry position where the contact section blocks a course of the medium in the conveyance direction, and, as the medium is conveyed and a downstream end portion in the conveyance direction of the medium comes into contact with the contact section from upstream in the conveyance direction, the contact section turns centering on the support shaft to retreat from the entry position to a retraction position where the contact section does not block the course.

According to this aspect, the plurality of restriction members are disposed side by side in the width direction and are capable of turning centering on the support shaft having the rotation axis in the width direction, the contact section is located at the entry position in the state in which the medium is absent in the conveyance path, and, as the downstream end portion of the medium comes into contact with the contact section from upstream in the conveyance direction, the contact section turns and retracts from the entry position to the retraction position. With the configuration explained above, even when media having various widths are used, the restriction member can guide the conveyance of the medium and can reduce a likelihood that the medium is caught by the restriction member and cannot be conveyed. That is, it is possible to improve medium conveyance accuracy.

A printing device according to a second aspect of the present disclosure is an aspect dependent from the first aspect, further including an urging member configured to urge the contact section in a direction from the retraction position toward the entry position, wherein an urging force of the urging member is smaller than a force of the contact section moving from the entry position toward the retraction position as the downstream end portion comes into contact with the contact section from upstream in the conveyance direction.

According to this aspect, the printing device includes the urging member configured to urge the contact section in the direction from the retraction position toward the entry position and the urging force of the urging member is smaller than the force of the contact section moving from the entry position toward the retraction position as the downstream end portion comes into contact with the contact section. With the configuration explained above, it is possible to suitably locate, at the entry position, the restriction member located on the outer side in the width direction of the conveyed medium and guide the conveyance of the medium and it is possible to suitably turn the restriction member located on the inner side in the width direction of the conveyed medium and retract the restriction member from the entry position to the retraction position as the restriction member is brought into contact with the contact section from upstream.

A printing device according to a third aspect of the present disclosure is an aspect dependent from the second aspect, wherein the restriction member has a shape expanding from upstream to downstream in the conveyance direction when viewed in the width direction.

According to this aspect, the restriction member has the shape expanding from upstream to downstream in the conveyance direction when viewed from in the width direction. With the configuration explained above, with a simple configuration, it is possible to suitably turn the restriction member located on the inner side in the width direction of the conveyed medium and retract the restriction member from the entry position to the retraction position as the restriction member is brought into contact with the contact section from upstream.

A printing device according to a fourth aspect of the present disclosure is an aspect dependent from the third aspect, further including a support member provided at a position where a part of the support member faces the medium conveyed in the conveyance path and configured to turnably support the restriction member, wherein the restriction member includes a side portion that is an end portion on the medium side in a direction from the support member to the medium conveyed in the conveyance path, and the side portion has a larger inclination angle with respect to the medium from upstream to downstream in the conveyance direction.

According to this aspect, the restriction member has the side portion that is the end portion on the medium side in the direction from the support member that turnably supports the restriction member toward the medium conveyed in the conveyance path and the side portion has the larger inclination angle with respect to the medium from upstream to downstream in the conveyance direction. With the configuration explained above, it is possible to particularly suitably turn the restriction member located on the inner side in the width direction of the conveyed medium and retract the restriction member from the entry position to the retraction position as the restriction member is brought into contact with the contact section from upstream.

A printing device according to a fifth aspect of the present disclosure is an aspect dependent from the fourth aspect, wherein the side portion has a taper shape tapered in a direction from the support member side toward the medium conveyed in the conveyance path.

According to this aspect, the side portion has the taper shape tapered in the direction from the support member side toward the medium conveyed in the conveyance path. With the configuration explained above, the restriction member can guide the medium with the taper shape and can suitably correct positional deviation of the conveyed medium in the width direction and guide the conveyance of the medium.

A printing device according to a sixth aspect of the present disclosure is an aspect dependent from the fourth or fifth aspect, further including a medium support member configuring the conveyance path and configured to support the conveyed medium, wherein the support member is disposed at a position where the support member sandwiches the conveyed medium in conjunction with the medium support member and is disposed such that an interval between the support member and the medium support member is narrowed from upstream to downstream in the conveyance direction.

According to this aspect, the support member that turnably supports the restriction member is disposed at a position where the support member sandwiches the conveyed medium in conjunction with the medium support member that supports the medium and is disposed such that the interval between the support member and the medium support member is narrowed from upstream to downstream in the conveyance direction. With the configuration explained above, even when the conveyed medium has a curved crease such as a curl or cockling, the curved crease and the support member can come into contact to reduce the curved crease in a place where the interval between the support member and the medium support member is narrowed and it is possible to suitably prevent the medium from being skewed and conveyed.

A printing device according to a seventh aspect of the present disclosure is an aspect dependent from any one of the fourth to sixth aspects, wherein the restriction members are disposed symmetrically in the width direction with a center position of the medium in the width direction as a boundary, and each of the restriction members has a shape symmetrical in the width direction.

According to this aspect, the restriction members are disposed symmetrically in the width direction with respect to the center position of the medium in the width direction, and each of the restriction members has a symmetrical shape in the width direction. With the configuration explained above, it is possible to bring the restriction members into contact with both end portions of the medium in the width direction, it is possible to suitably guide the conveyance of the medium, it is possible to use the respective restriction members as common members and, it is possible to increase production efficiency of the restriction members.

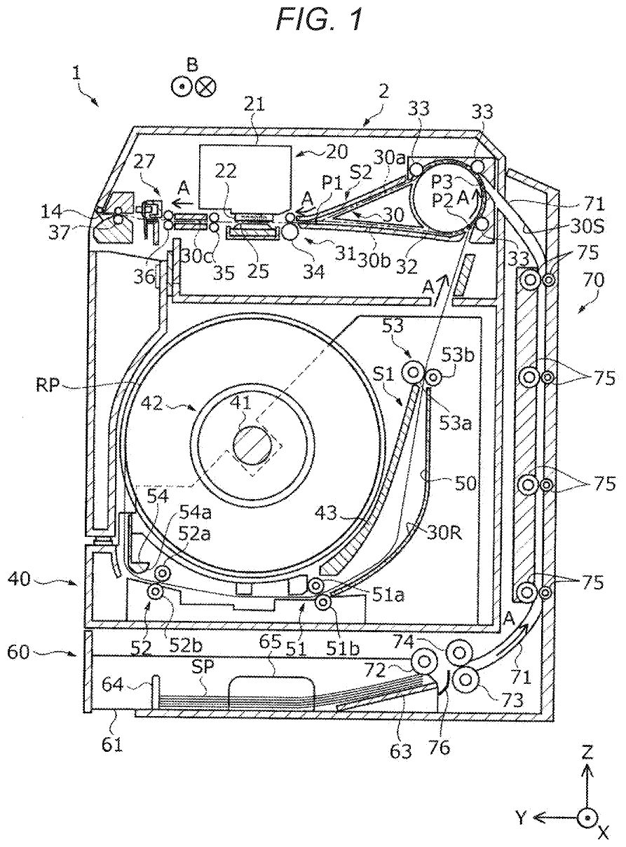

Hereinafter, an embodiment according to the present disclosure is specifically explained with reference to the drawings. First, an overview of a printing device 1 according to an embodiment of the present disclosure is explained with reference to FIG. 1. The printing device 1 is, for example, an inkjet printer that ejects ink onto a medium to perform printing. In a coordinate added to the drawings, assuming that the printing device 1 is placed on the horizontal plane, three virtual axes orthogonal to one another are represented as an X axis, a Y axis, and a Z axis. The Y axis is an axis parallel to the front-rear direction of the printing device 1 and a tip side of an arrow indicating the Y axis is represented as “front”. The X axis is an axis parallel to the left-right direction of the printing device 1 and a tip side of an arrow indicating the X axis is represented as “right”. The Z axis is a virtual axis parallel to the vertical direction and a tip side of an arrow indicating the Z axis is represented as “upper”.

As illustrated in FIG. 1, the printing device 1 includes a housing 2. On the inside of the housing 2, a roll paper storing section 40 that stores roll paper RP, which is a medium, a single sheet paper storing section 60 that stores single sheet paper SP, which is a medium other than the roll paper RP, and a printing section 20 capable of performing printing on the roll paper RP supplied from the roll paper storing section 40 and capable of performing printing on the single sheet paper SP supplied from the single sheet paper storing section 60 are provided.

The printing section 20 includes a head 22 including nozzles that eject ink toward the medium and a carriage 21 on which the head 22 is mounted. The printing section 20 is configured to be capable of reciprocating the carriage 21 along the X axis. A support section 25 that supports the medium is provided at a position facing the head 22. The head 22 performs printing on the medium supported by the support section 25 by discharging ink while reciprocating in the width direction B together with the carriage 21. In the embodiment, a serial head type in which the head 22 reciprocates in the width direction is exemplified as the printing section 20. However, the printing section 20 may be a line head type printing section in which a head extends in the width direction and is fixedly arrayed.

A conveyance path 30 through which the medium is conveyed and a cutting section 27 capable of cutting the medium printed by the printing section 20 are provided on the inside of the housing 2. The conveyance path 30 includes a supply path 30a and a reverse path 30b provided further upstream than the support section 25 and a discharge path 30c provided further downstream than the support section 25. Furthermore, the supply path 30a includes a roll paper supply path 30R through which roll paper, which is an example of the medium, is supplied and a single sheet paper supply path 30S through which the single sheet paper SP, which is an example of the medium, is supplied.

The supply path 30a is a path connecting the roll paper supply path 30R to the support section 25. A roll paper merging point P2 of merging with the roll paper supply path 30R is provided upstream of the supply path 30a. A branch point P1 of branching from the supply path 30a when the medium is conveyed from downstream to upstream is provided downstream of the supply path 30a. The reverse path 30b is a path connecting the branch point P1 to the roll paper merging point P2. A single sheet paper merging point P3 of merging with the single sheet paper supply path 30S is provided between the roll paper merging point P2 and the branch point P1 in the supply path 30a.

A discharge port 14 through which a printed medium is discharged is provided on the front surface of the housing 2. The discharge path 30c is a path connecting the support section 25 to the discharge port 14. A cutting section 27 that cuts the medium printed by the printing section 20 is provided halfway in the discharge path 30c.

In the conveyance path 30, a conveyance section 31 that conveys the medium supplied to the conveyance path 30 is provided. The conveyance section 31 includes an intermediate roller 32, a plurality of driven rollers 33 provided on the outer circumference of the intermediate roller 32, and an upstream conveyance roller pair 34 in order from upstream in the supply path 30a. The driven roller 33 is rotatably provided and is driven to rotate with the medium sandwiched between the driven roller 33 and the intermediate roller 32. The conveyance section 31 includes a downstream conveyance roller pair 35, a roller pair 36, and a roller pair 37 in order from upstream in the discharge path 30c. The roller pair 36 is located upstream of the cutting section 27 and the roller pair 37 is located downstream of the cutting section 27.

The intermediate roller 32, the driven roller 33, the upstream conveyance roller pair 34, the downstream conveyance roller pair 35, the roller pair 36, and the roller pair 37 convey the medium by rotating in a state of sandwiching the medium. The conveyance section 31 is driven to rotate forward, whereby the medium is conveyed from upstream to downstream in the conveyance direction A, that is, the forward direction. The conveyance section 31 is driven to reversely rotate, whereby the medium is conveyed from downstream to upstream in a direction opposite to the conveyance direction A, that is, the opposite direction.

The printing device 1 ejects the ink from the printing section 20 onto the medium located on the support section 25 while driving the conveyance section 31 to rotate forward and conveying the medium from upstream to downstream and performs printing on a first surface of the medium. The printing device 1 is configured to be capable of performing printing on a second surface that is a back surface of the first surface of the medium. The printing device 1 drives the conveyance section 31 to reversely rotate to convey, in the opposite direction, the medium after being printed on the first surface. The medium reaches upstream of the supply path 30a from the branch point P1 through the reverse path 30b. The printing device 1 drives the conveyance section 31 to rotate forward again and the medium makes full one turn around the outer circumference of the intermediate roller 32, whereby the front and back of the medium are reversed. The printing device 1 ejects the ink from the printing section 20 onto the medium located in the support section 25 while conveying the medium from upstream to downstream and performs printing on the second surface of the medium. Accordingly, printing is executed on both the surfaces of the medium. In the case of the roll paper RP obtained by unwinding the medium from a roll state, printing on the back surface is executed on the medium cut into a single sheet paper state by the cutting section 27 after the printing on the front surface.

A roll paper storing section 40 is provided on the inside of the housing 2. The roll paper storing section 40 includes a first medium holding section 42 that holds the roll paper RP in a roll body state. The roll paper RP is rotatably supported via a support shaft 41 extending in the X direction of the housing 2. That is, the roll paper RP is rotatably supported by the roll paper storing section 40 together with the support shaft 41 with the support shaft 41 as a rotation center. The support shaft 41 is configured to be rotatable in both of a forward rotation direction and a reverse rotation direction. In the roll paper storing section 40, a roll paper conveyance path 50 that conveys the roll paper RP unwound from the roll state is provided at a position facing a support member 43. The roll paper conveyance path 50 configures the roll paper supply path 30R.

The roll paper conveyance path 50 includes a first roller pair 51, a second roller pair 52, a third roller pair 53, and a curved surface section 54. The first roller pair 51 includes a driving roller 51a driven by a motor and a driven roller 51b facing the driving roller 51a and driven to rotate as the driving roller 51a rotates. The second roller pair 52 includes a driving roller 52a driven by a motor and a driven roller 52b facing the driving roller 52a and driven to rotate as the driving roller 52a rotates. The third roller pair 53 includes a driving roller 53a driven by a motor and a driven roller 53b facing the driving roller 53a and driven to rotate as the driving roller 53a rotates. The curved surface section 54 has a curved surface 54a on which the conveyed medium slides. In the roll paper conveyance path 50, the first roller pair 51, the second roller pair 52, and the third roller pair 53 are driven to rotate forward, whereby the medium is conveyed from upstream to downstream in the conveyance direction A, that is, the forward direction while being pressed against the curved surface 54a of the curved surface section 54.

The single sheet paper storing section 60 is provided on the inside of the housing 2. The single sheet paper storing section 60 includes a box-shaped tray 61 in which the single sheet paper SP, which is a single sheet medium, is stored. The tray 61 includes a pair of edge guides 65 operated when positioning the single sheet paper SP in the width direction, a stopper 64 operated when positioning the single sheet paper SP in the front-rear direction, and a placement surface 63 on which a downstream end portion of the single sheet paper SP stored in the tray 61 faces the pickup roller 72.

The single sheet paper storing section 60 forms a part of a single sheet paper supply unit 70 that supplies the single sheet paper SP toward the printing section 20. The single sheet paper supply unit 70 includes the single sheet paper storing section 60 including the placement surface 63 serving as a placement section on which a plurality of pieces of single sheet paper SP can be placed, a single sheet paper conveyance path 71, a pickup roller 72, a retard roller 73, a separation roller 74, serving as feeding rollers that are provided at a position facing the single sheet paper storing section 60 and feed the single sheet paper SP placed on the single sheet paper storing section 60 in the conveyance direction A from the single sheet paper storing section 60 toward the printing section 20, a separation member 76, and the like.

The single sheet paper conveyance path 71 is bent upward from the separation roller 74 and the retard roller 73 and configures the single sheet paper supply path 30S. In the single sheet paper conveyance path 71, a single sheet paper conveyance roller pair 75 that applies a conveyance force to the single sheet paper SP is provided at an appropriate interval. The single sheet paper SP is conveyed by rotationally driving the single sheet paper conveyance roller pair 75.

As explained above, the printing device 1 in the present embodiment includes the conveyance section 31 that conveys the medium in the conveyance direction A along the conveyance path 30, the printing section 20 facing the medium conveyed in the conveyance path 30, and the first medium holding section 42 that holds the roll paper RP serving as the first medium in the roll body state. Furthermore, as illustrated in FIG. 1, the printing device 1 in the present embodiment includes, in a region S1 of the support member 43 and a region S2 configuring the supply path 30a, a plurality of restriction members 100 that restrict movement of the medium in the width direction B intersecting the conveyance direction A.

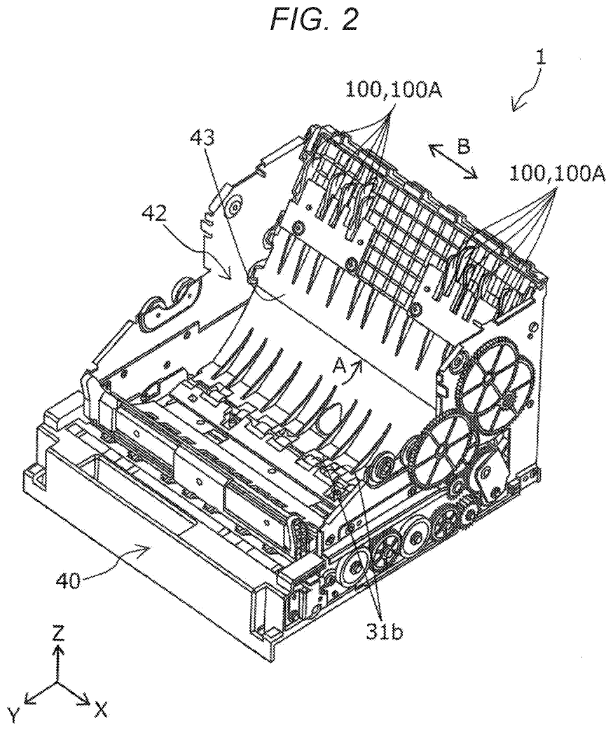

Thus, hereinafter, the restriction member 100 is explained in detail with reference to FIGS. 2 to 7. A first restriction section 100A, which is the restriction member 100 provided in the region S1, and a second restriction section 100B, which is the restriction member 100 provided in the region S2, have the same configuration. For this reason, in the following explanation, the restriction member 100 is explained using the first restriction section 100A as an example. However, the second restriction section 100B can be regarded as the same.

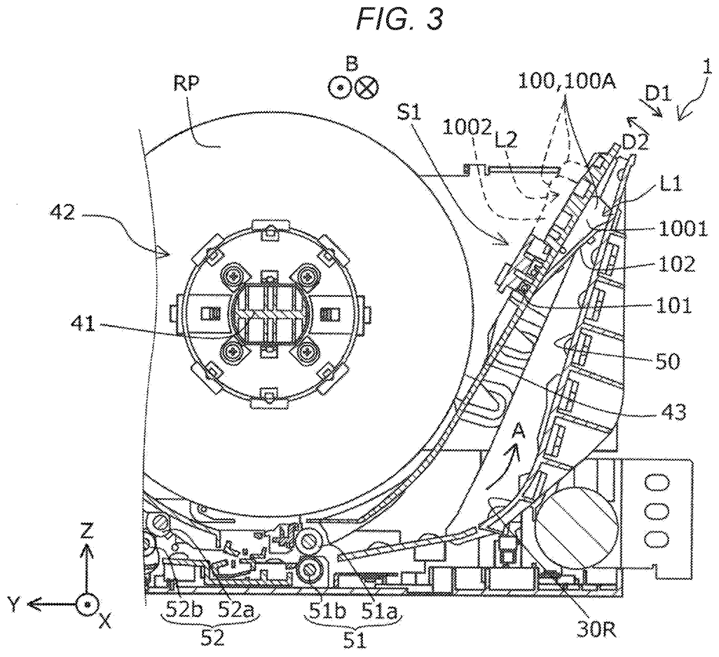

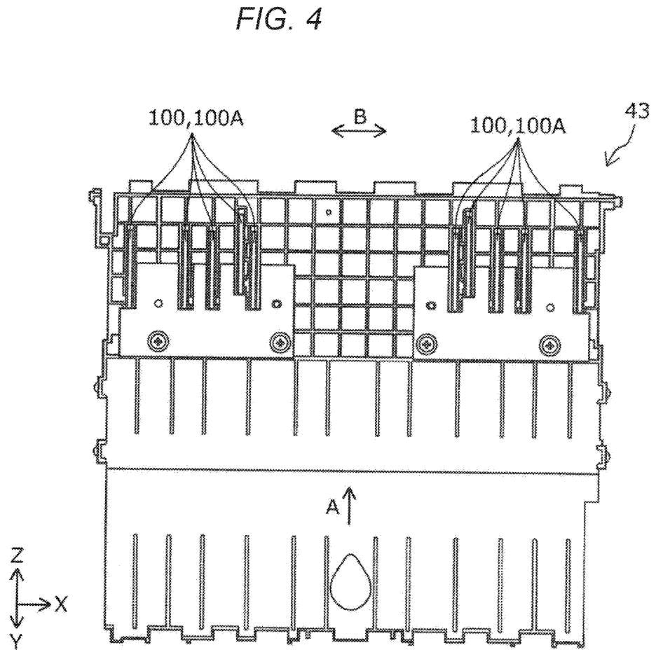

As illustrated in FIGS. 2 and 4, the restriction members 100 are disposed side by side in the width direction B. As illustrated in FIGS. 3, 5, and 6, the restriction member 100 includes a support shaft 101 having a rotation axis in the width direction B and is configured to be turnable in a turning direction D1 and a turning direction D2 centering on the support shaft 101 as illustrated in FIG. 3. As illustrated in FIGS. 3, 5, and 6, the restriction member 100 includes a contact section 102 capable of coming into contact with the conveyed medium.

In a state in which the medium is absent in the conveyance path 30, as in a state 1001 indicated by a solid line in FIG. 3, the contact section 102 of the restriction member 100 is located at an entry position L1 where the contact section 102 blocks a course of the medium in the conveyance direction A. Then, as the medium is conveyed and the downstream end portion in the conveyance direction A of the medium comes into contact with the contact section 102 from upstream in the conveyance direction A, as in a state 1002 indicated by a broken line in FIG. 3, the contact section 102 turns in the turning direction D2 centering on the support shaft 101 and retracts from the entry position L1 to a retraction position L2 where the contact section 102 does not block the course of the medium. In FIG. 3, the restriction member 100 in the state 1001 in which the contact section 102 is present at the entry position L1 is indicated by a solid line and the restricting member 100 in the state 1002 in which the contact section 102 is present at the retraction position L2 is indicated by a broken line.

With the configuration explained above, in the printing device 1 in the present embodiment, even when media having various widths are used, the restriction member 100 can guide the conveyance of the media and can reduce a likelihood that the media are caught by the restriction member 100 and cannot be conveyed. That is, the printing device 1 in the present embodiment can improve medium conveyance accuracy. Specifically, the restriction member 100 at a position overlapping the inside of the medium conveyed in the width direction B among the plurality of restriction members 100 presses the medium in the surface direction while retracting to the retraction position L2 as the restriction member 100 comes into contact with the leading end of the conveyed medium. On the other hand, the restriction member 100 located on the outside of the medium conveyed in the width direction B among the plurality of restriction members 100 guides the medium not to deviate in a position in the width direction B while keeping a state of being located at the entry position L1 because there is no contact with the leading end of the conveyed medium.

Furthermore, since the plurality of restriction members 100 are disposed side in side in the width direction B, it is possible to guide the conveyance of the medium while suitably correcting the positional deviation in the width direction B of the medium according to a size of the medium. Since the contact section 102 is provided at a position having length from the support shaft 101, which is the rotation center, it is possible to reduce a load of pressing the medium with a rotation moment.

It is possible to locate the contact section 102 of a desired restriction member 100 at the retraction position L2 and locate the contact sections 102 of the other restriction members 100 at the entry position L1 at the same time while conveying the medium. Since the restriction member 100 has a structure of waiting for a conveyed medium, even when media having various widths are used, the restriction member 100 can be suitably automatically located at the entry position L1 and the retraction position L2. It is unnecessary for the user to change the disposition of the restriction member 100. The restriction member 100 can be disposed at various positions in the conveyance path 30.

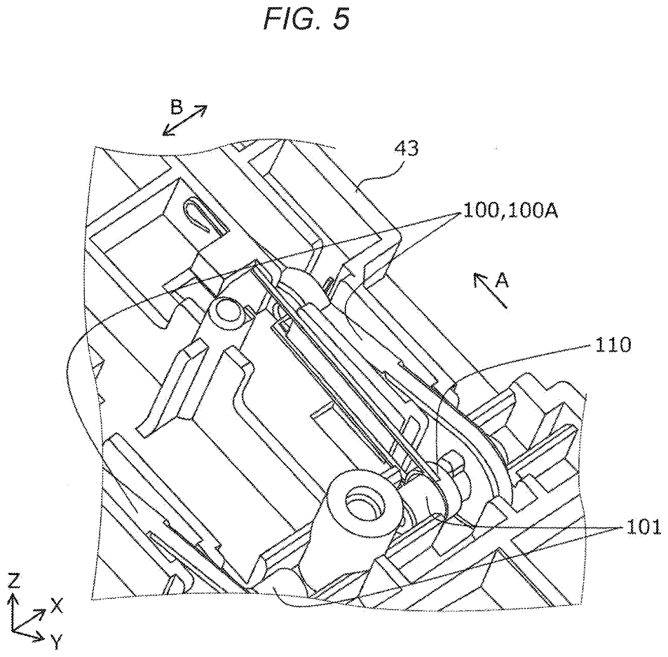

As illustrated in FIG. 5, the printing device 1 in the present embodiment includes a torsion spring 110 serving as an urging member. The torsion spring 110 urges the contact section 102 in the turning direction D1, which is a direction from the retraction position L2 to the entry position L1. Here, an urging force of the torsion spring 110 is smaller than a force of the contact section 102 moving from the entry position L1 to the retraction position L2 as the downstream end portion of the medium comes into contact with the contact section 102 from upstream in the conveyance direction A.

With the configuration explained above, the printing device 1 in the present embodiment can suitably locate, at the entry position L1, the restriction member 100 located on the outer side in the width direction B of the conveyed medium to guide the conveyance of the medium and can suitably turn the restriction member 100 located on the inner side in the width direction B of the conveyed medium to retreat from the entry position L1 to the retraction position L2 as the restriction member 100 is brought into contact with the contact section 102 from upstream.

As illustrated in FIG. 3, the printing device 1 in the present embodiment has a configuration in which the support member 43 that turnably supports the restriction member 100 based on the conveyance section 31 is provided substantially above and the roll paper conveyance path 50 serving as the medium support member is provided substantially below. The restriction member 100 is configured to move the medium from substantially above to substantially below such that the contact section 102 moves from the retraction position L2 to the entry position L1. However, without being limited to the configuration explained above, the restriction member 100 may be provided substantially below based on the conveyance section 31 and configured to move the medium from substantially below to substantially above such that the contact section 102 moves from the retraction position L2 to the entry position L1.

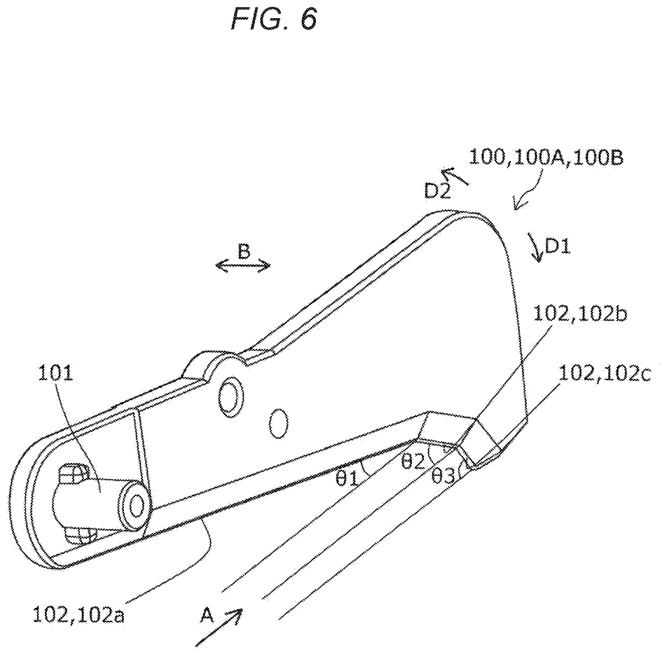

As illustrated in FIG. 6, the restriction member 100 in the present embodiment has a shape expanding from upstream to downstream in the conveyance direction A when viewed in the width direction B. With the configuration explained above, with a simple configuration, the restriction member 100 located on the inner side in the width direction B of the conveyed medium can be suitably turned and retracted from the entry position L1 to the retraction position L2 as the restriction member 100 is brought into contact with the contact section 102 from upstream.

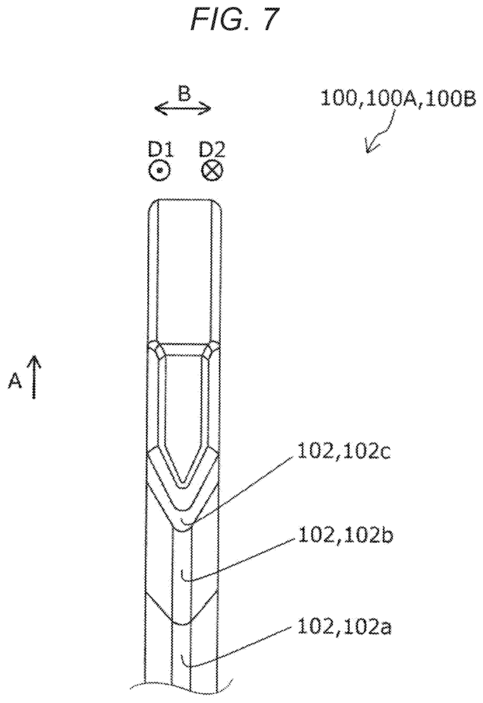

As illustrated in FIGS. 1 and 3, the printing device 1 in the present embodiment includes, at a position where a part of the restriction member 100 faces the medium conveyed in the conveyance path 30, the first medium holding section 42 that turnably supports the restriction member 100. As illustrated in FIGS. 6 and 7, the restriction member 100 includes the contact section 102 serving as the side portion that is the end portion on the medium side in the turning direction D1, which is the direction from the first medium holding section 42 toward the medium conveyed in the conveyance path 30.

Here, the contact section 102 has a side portion 102a, a side portion 102b, and a side portion 102c and has a larger inclination angle with respect to the medium from upstream to downstream in the conveyance direction A. Specifically, in FIG. 6, an angle θ2 formed by the conveyance direction A and the side portion 102b is larger than an angle θ1 formed by the conveyance direction A and the side portion 102a and an angle θ3 formed by the conveyance direction A and the side portion 102c is larger than the angle θ2 formed by the conveyance direction A and the side portion 102b. With the configuration explained above, the restriction member 100 located on the inner side in the width direction B of the conveyed medium can be particularly suitably turned and retracted from the entry position L1 to the retraction position L2 as the restriction member 100 is brought into contact with the contact section 102 from upstream.

As illustrated in FIGS. 6 and 7, the contact section 102 serving as the side portion has a taper shape. Specifically, the contact section 102 has a taper shape tapered toward the turning direction D1, which is the direction from the support member 43 side toward the medium conveyed in the conveyance path 30. With the configuration explained above, the restriction member 100 can guide the medium with the taper shape and can suitably correct positional deviation of the conveyed medium in the width direction B and guide the conveyance of the medium.

As explained above, the printing device 1 in the present embodiment includes the roll paper conveyance path 50 serving as the medium support member that configures the conveyance path 30 and supports the conveyed medium. Here, as illustrated in FIGS. 1 and 3, the support member 43 is disposed at a position where the support member 43 sandwiches the conveyed medium in conjunction with the roll paper conveyance path 50 and is disposed such that the interval between the support member 43 and the roll paper conveyance path 50 is narrowed from upstream to downstream in the conveyance direction A.

With the configuration explained above, even when the conveyed medium has a curved crease such as a curl or cockling, the curved crease and the support member 43 come into contact and the crease can be reduced at a place where the interval between the support member 43 and the roll paper conveyance path 50 is narrowed and it is possible to suitably prevent the medium from being skewed and conveyed. In other words, the medium meanders up and down as being conveyed. However, receiving surfaces can be configured up and down with respect to the up and down meandering of the medium.

In the printing device 1 in the present embodiment, as illustrated in FIG. 4, the plurality of restriction members 100 are disposed symmetrically in the width direction B with the center position of the medium in the width direction B as a boundary. As illustrated in FIG. 6, each of the restriction members 100 has a symmetrical shape in the width direction B.

With the configuration explained above, it is possible to bring the restriction member 100 into contact with both the end portions of the medium in the width direction B, it is possible to suitably guide the conveyance of the medium, it is possible to use the respective restriction members 100 as common members, and it is possible to increase production efficiency of the restriction member 100. In other words, since the disposition of each of the restriction members 100 is not determined, assemblability of the printing device 1 is high, components are unified, and cost can be reduced.

The printing device 1 in the present embodiment is configured to convey the medium with the center in the width direction of the medium aligned with the center in the width direction B of the conveyance path 30. However, the printing device 1 is not limited to the configuration explained above. For example, the printing device 1 may be configured to convey the medium with one end portion in the width direction of the medium aligned with one end portion in the width direction B of the conveyance path 30. In the configuration explained above, the printing device 1 can have a configuration in which a plurality of restriction members 100 are disposed at the other end portion in the width direction B. In other words, the printing device 1 can have a configuration in which a wall is provided on one side in the width direction B of the conveyance path 30 and, when the medium is conveyed based on the wall and the conveyed medium deviates in a position to the other side in the width direction B, the conveyance of the medium is guided by the restriction member 100 provided on the other side opposite to the wall.

As illustrated in FIG. 1, the printing device 1 in the present embodiment includes, as the conveyance path 30, the roll paper supply path 30R and the supply path 30a serving as a first conveyance path and the single sheet paper supply path 30S and the reverse path 30b serving as a second conveyance path. The conveyance path 30 includes the roll paper merging point P2 and the single sheet paper merging point P3 serving as the merging sections where the first conveyance path and the second conveyance path merge. The first medium holding section 42 holds the roll paper RP serving as the first medium in the roll body state.

The roll paper RP is conveyed from the first medium holding section 42 through the roll paper supply path 30R and the supply path 30a serving as the first conveyance path, is not conveyed through the single sheet paper supply path 30S and the reverse path 30b serving as the second conveyance path, and is conveyed to the printing position facing the printing section 20. Here, the first restriction section 100A among the restriction members 100 is provided in the region S1, in other words, in the first conveyance path. Note that “not conveyed through the single sheet paper supply path 30S and the reverse path 30b serving as the second conveyance path” means that the roll paper RP is not conveyed in a long state continuous from the roll paper RP and does not mean that single sheet paper obtained by cutting the roll paper RP with the cutting section 27 explained below is not conveyed.

In the printing device 1 in the present embodiment, since the roll paper RP is conveyed through the first conveyance path but is not conveyed through the second conveyance path, it is possible to prevent the conveyance path 30 of the roll paper RP from becoming too long. Even when the medium is once rewound further upstream than the restriction member 100 and conveyed again, it is possible to reduce a likelihood that a skew degree of the medium gradually increases and a conveyance position greatly deviates in the width direction B. Since the first restriction section 100A is provided in the first conveyance path, the first restriction section 100A can guide the conveyance of the medium in the first conveyance path and can reduce a likelihood that the medium is caught by the restriction member 100A and cannot be conveyed. That is, it is possible to improve medium conveyance accuracy.

As illustrated in FIG. 1, the printing device 1 in the present embodiment includes the third roller pair 53 in the roll paper supply path 30R serving as the first conveyance path. However, the third roller pair 53 also plays a role of a first medium leading end holding section capable of holding the downstream end portion, which is the leading end in the conveyance direction A of the roll paper RP. As illustrated in FIG. 1, the first restriction section 100A is disposed further upstream in the conveyance direction A than the third roller pair 53.

In other words, in the printing device 1 in the present embodiment, the restriction member 100 is disposed upstream of a standby position of the medium. With the configuration explained above, the printing device 1 in the present embodiment can guide the conveyance of the medium before the downstream end portion of the medium reaches the third roller pair 53 serving as the first medium leading end holding section and can suitably improve the medium conveyance accuracy. When a long medium continuous to the roll paper RP is conveyed through the roll paper supply path 30R in the conveyance direction A, the third roller pair 53 serving as the first medium leading end holding section can hold the leading end of the medium and wait in that state.

As illustrated in FIG. 1, the printing device 1 in the present embodiment includes, further downstream in the conveyance direction A than the printing section 20, the cutting section 27 capable of cutting the roll paper RP. The reverse path 30b serving as the second conveyance path can convey the single sheet paper obtained by cutting the roll paper RP conveyed from the first medium holding section 42 with the cutting section 27. With the configuration explained above, the printing device 1 in the present embodiment can, after improving the medium conveyance accuracy, obtain a printed image formed object using the long roll paper RP as the single sheet paper.

As illustrated in FIG. 1, the printing device 1 in the present embodiment includes the upstream conveyance roller pair 34. The upstream conveyance roller pair 34 also plays a role of the second medium holding section capable of holding the single sheet paper. The single sheet paper supply path 30S and the reverse path 30b serving as the second conveyance path are capable of conveying the single sheet paper.

With the configuration explained above, the printing device 1 in the present embodiment can perform printing on the single sheet paper after improving the medium conveyance accuracy. When a medium formed as single sheet paper by cutting a long medium continuous to the roll paper RP with the cutting section 27 and single sheet paper conveyed from the single sheet paper storing section 60 in the conveyance direction A are conveyed further downstream in the conveyance direction A than the merging section (the roll paper merging point P2 and the single sheet paper merging point P3) via the merging section, the upstream conveyance roller pair 34 serving as the second medium leading end holding section can hold the leading ends of the medium and the single sheet paper and wait in that state.

As illustrated in FIG. 1, the printing device 1 in the present embodiment has a configuration in which only one roll body of the roll paper RP can be set. However, the printing device 1 is not limited to the configuration explained above. For example, the printing device 1 may have a configuration in which a third medium holding section that holds a long medium in a state of a roll body different from the roll paper RP held by the first medium holding section 42 is provided, for example, below the first medium holding section 42 and the second roll paper supply path 30R serving as the second conveyance path is capable of conveying the long medium from the third medium holding section. With the configuration explained above, it is possible to perform printing on two types of long media after improving the medium conveyance accuracy. In the configuration explained above, the third medium holding section may be configured the same as the first medium holding section 42 and the second roll paper supply path 30R serving as the second conveyance path can be configured that same as the roll paper supply path 30R serving as the first conveyance path by, for example, disposing the restriction member 100 in the second roll paper supply path 30R.

As explained above, the printing device 1 in the present embodiment includes, in the region S2, the second restriction section 100B serving as the restriction member 100 that restricts the movement of the medium in the width direction B. In other words, the second restriction section 100B is provided, in the conveyance direction A, at a position between the printing section 20 and the roll paper merging point P2 or the single sheet paper merging point P3 serving as the merging section. With the configuration explained above, the restriction member 100 is disposed at a position near the printing section 20, the position being an upstream position at the time of printing standby in the conveyance direction A, and printing can be performed after particularly suitably improving the medium conveyance accuracy.

The present disclosure is not limited to the embodiment explained above and can be implemented in various configurations without departing from the gist of the present disclosure. In order to solve some or all of the problems described above or to achieve some or all of the effects described above, the technical features in the embodiment corresponding to the technical features in the respective aspects described in the summary can be substituted or combined as appropriate. The technical features can be eliminated as appropriate unless being explained as essential technical features in the present specification.

What is claimed is:

1. A printing device comprising:
a conveyance section configured to convey a medium in a conveyance direction along a conveyance path;
a printing section facing the medium conveyed in the conveyance path; and
a plurality of restriction members located further upstream than the printing section in the conveyance direction of the conveyance path and configured to restrict movement of the medium in a width direction intersecting the conveyance direction, wherein
the restriction members are disposed side by side in the width direction and are turnable centering on a support shaft having a rotation axis in the width direction,
in a state in which the medium is absent in the conveyance path, a contact section is located at an entry position where the contact section blocks a course of the medium in the conveyance direction, and
as the medium is conveyed and a downstream end portion in the conveyance direction of the medium comes into contact with the contact section from upstream in the conveyance direction, the contact section turns centering on the support shaft to retreat from the entry position to a retraction position where the contact section does not block the course.

2. The printing device according to claim 1, further comprising an urging member configured to urge the contact section in a direction from the retraction position toward the entry position, wherein
an urging force of the urging member is smaller than a force of the contact section moving from the entry position toward the retraction position as the downstream end portion comes into contact with the contact section from upstream in the conveyance direction.

3. The printing device according to claim 2, wherein the restriction member has a shape expanding from upstream to downstream in the conveyance direction when viewed in the width direction.

4. The printing device according to claim 3, further comprising a support member provided at a position where a part of the support member faces the medium conveyed in the conveyance path and configured to turnably support the restriction member, wherein
the restriction member includes a side portion that is an end portion on the medium side in a direction from the support member to the medium conveyed in the conveyance path, and
the side portion has a larger inclination angle with respect to the medium from upstream to downstream in the conveyance direction.

5. The printing device according to claim 4, wherein the side portion has a taper shape tapered in a direction from the support member side toward the medium conveyed in the conveyance path.

6. The printing device according to claim 4, further comprising a medium support member configuring the conveyance path and configured to support the conveyed medium, wherein
the support member is disposed at a position where the support member sandwiches the conveyed medium in conjunction with the medium support member and is disposed such that an interval between the support member and the medium support member is narrowed from upstream to downstream in the conveyance direction.

7. The printing device according to claim 4, wherein
the restriction members are disposed symmetrically in the width direction with a center position of the medium in the width direction as a boundary, and
each of the restriction members has a shape symmetrical in the width direction.
